(19) United States
(12) Patent Application Publication
(10) Pub. No.: US 2014/0012605 A1
(43) Pub. Date: Jan. 9, 2014

(54) METHOD OF RE-DISTRIBUTING AND REALIZING WEALTH BASED ON VALUE OF INTANGIBLE ASSETS OR OTHER ASSETS

(71) Applicant: VEDETT IP COPROPRATION, Calgary (CA)

(72) Inventor: Arthur M. SZABO, Calgary (CA)

(21) Appl. No.: 13/935,521

(22) Filed: Jul. 4, 2013

Related U.S. Application Data
(60) Provisional application No. 61/668,005, filed on Jul. 4, 2012.

(51) Int. Cl. G06Q 40/06

(52) U.S. Cl. CPC G06Q 40/06
USPC 705/4

(57) ABSTRACT

Methods of re-distributing and realizing wealth based on the value of intangible, tangible or other assets are described. For example, one or more intangible assets, including but not limited to the company's established goodwill, may be sold to a purchaser corporation in exchange for an issuance of shares in the purchaser corporation's capital stock. Rights in the intangible assets may then be leased back to the seller company on terms that provide for the payment of periodic rent to the purchaser corporation. With the seller company's intangible assets having been converted at least partially into tangible, recordable investment property, the purchaser corporation may extend a credit facility to the seller company secured by the acquired shares in the corporation's issued capital stock. Loan advances drawn on the credit facility may then be taken by the seller company from time to time so as to generate positive real cash flows to the seller company.

### CROSS-REFERENCE TO RELATED APPLICATION

This application claims all benefit, including priority, of U.S. Provisional Patent Application Ser. No. 61/668,005, filed 4 Jul. 2012 and entitled, “Method of Re-Distributing and Realizing Wealth based on Value of Intangible or other Assets,” the entire contents of which, including all Appendices, are incorporated herein by this reference.

### TECHNICAL FIELD

The disclosure relates generally to the distribution of wealth and, more specifically, to the re-distribution and realization of wealth through disposition, conveyance, transfer, and/or conversion of goodwill or other intangible assets.

### DISCLAIMER

This application contains material describing method(s) and process(es) broadly directed to, and practical applications of, financing agreements and other commercial transactions engaged in by businesses. Aspects of financing or other agreements, corporate governance and operation, commerce, and other spheres of private or public activity are in some cases regulated by laws or governmental and other agencies. The disclosure herein is made solely in terms of logical, technical, and economic possibility, without regard to possible statutory, regulatory, or other legal considerations. Nothing herein is intended as a statement or representation that any method, process or application proposed or discussed herein does or does not comply, either wholly or in part, with any statute, law, regulation, or other legal requirement in any jurisdiction; nor should any material presented herein be taken or construed as doing so.

A portion of the disclosure of this patent document, including any attached drawings or appendices, may contain material which is subject to copyright protection. The copyright owner has no objection to the facsimile reproduction by anyone of the patent document or the patent disclosure, for purposes of understanding it, as it appears in Patent Office files or records following publication, but otherwise reserves all copyrights whatsoever.

### BACKGROUND

Lending is commonplace in business. A loan is a type of debt that entails the redistribution of financial assets over a period of time between lender and borrower. In a typical loan arrangement, the lender initially offers an amount of money (sometimes called the “principal”) to the borrower who is obligated to repay the amount borrowed at the end of the term of the loan. Loans are also generally (but not always) provided by the lender at a cost to the borrower in the form of interest owing on the principal. A requirement for the payment of interest can provide incentive for a lender to participate in a loan by, among other things, hedging some of the risk that the borrower may ultimately default on the loan.

Protection for lenders against default on a loan may also, or alternatively, be provided in the form of secured lending. A secured loan (in contrast to an unsecured loan) is one in which the borrower pledges some asset or assets to the lender as collateral for the loan. The debt may thereby be secured against the collateral. Should the borrower fail to make full repayment on the loan, the lender may by operation of the security interest taken be entitled to take possession of the asset (s) designated as collateral, so as to realize any outstanding amount owing on the loan. In an unsecured loan, where no collateral is offered, the lender has no commensurate remedy against default, and instead must seek redress from the borrower directly, e.g., through initiation of a court action or equivalent proceeding.

In general, the added protection afforded secured lenders may enable loans to be offered at interest rates lower than rates for unsecured loans, which provide lenders with few remedies in cases of default. However, borrowers must be in a position to offer up valuable assets to serve as collateral for the secured lender in order to enjoy the benefits of such lower interest rates. The value of a prospective borrower's tangible, recordable assets therefore may place constraints, along with other such factors as credit history, ability to repay, and expected returns for the lender, on the borrower's ability to access credit.

### SUMMARY

In one aspect, the invention provides, in methods of distributing wealth comprising purchase of one or more assets of a seller company by a purchaser corporation in exchange for a plurality of shares in the issued stock of the purchaser corporation, the value of the issued shares determined based on the value of the assets sold; lease-back by the purchaser corporation to the seller company of purchased intangible assets; payment by the purchaser corporation of at least a portion of a net income generated from the lease payments of the seller, as dividends issued in respect of the shares exchanged for the purchased intangible assets; and holding by the purchaser corporation of the shares exchanged for the purchased intangible assets, as security for the lease-back of the purchased assets; improvements comprising advancement by the purchaser corporation to the seller company or one or more affiliates, other related entities, and/or otherwise-designated entities, of funds secured by at least one insurance policy.

In various embodiments, funds may be advanced to a seller company, and/or to one or more other designated businesses, through, for example, the implementation of loan facility(ies) and/or purchase(s) of preferred shares in the seller company.

In embodiments of the invention in which funds are advanced through the use of loan facility(ies), amounts of such funds may be capped based on a value of the asset(s) sold by the seller company to the purchaser corporation, and/or by other suitable criteria.

In the same and other embodiments of the invention in which funds are advanced through the use of loan facility(ies), at least partial repayment to the purchaser corporation of funds provided to the seller company under the loan facility may be made using proceeds of the at least one insurance policy.

In embodiments of the invention in which funds are advanced through purchase by the purchaser corporation of preferred shares in the seller company, such purchase may be subject to a shareholder agreement comprising a wide variety of terms. For example, such agreements can provide for repurchase and/or redemption of the preferred shares by the seller company at any time approved by a board of directors which controls the seller company, in the event of a change of control of the seller company, in the event of a material sale of assets or change of business of the seller company, and in the event of the death or other incapacity of one or more key persons associated with the seller company, payment by the seller company of dividends, etc.

As used in this specification, the term preferred shares refers to any class of equity security(ies) having a feature, or combination of features, which may or may not be possessed by any other class of stock in the selling corporation, including but not limited to any or all of preferences in dividend payment, accumulation of unpaid dividends, repurchase, redemption, and/or voting rights, and/or any other preferences in treatment of or priority to any other security(ies) of any sort. As will be understood by those skilled in the relevant arts, when they have been made familiar with this disclosure, the disclosure and discussion of preferred shares in this document is cast in logical and economic terms only, and is not intended to be bound or constrained by common current or historical business understandings of preferred shares.

As previously noted, advancement of funds by a purchaser corporation to the seller company may be in the form of loan(s) and/or purchase of preferred shares, and may be secured by one or more insurance policies taken out by the seller company. For purposes of this specification, the term ‘seller company’ in this context will be taken to include any designated affiliates, other related entities, including for example any parent and/or sister companies, and/or otherwise-designated (and potentially unrelated) entities, which have been agreed between the affected parties. Alternatively, any such related or otherwise-designated entities may be referred to as secured, insured, and/or financed entities, as appropriate.

In various embodiments of the invention, insurance policies provided as security for funds advanced by the purchaser corporation to the seller company may include life and/or disability policies which insure the life and/or capacity of one or more persons associated with the seller company. Such persons may include key seller company personnel such as board members, executives, managers, and key technical personnel.

Thus, in various aspects invention provides method(s) of re-distributing and/or realizing wealth based on the value of intangible and optionally other assets. Such method(s) may involve sale of one or more intangible assets, such as but not limited to a company's brand, business processes, know-how, customer/client base and other goodwill, to a purchaser corporation (or other entity). As payment for the intangible and/or other asset(s) acquired, the purchaser corporation may issue a plurality of shares in the purchaser corporation's capital stock (or other ownership or equity interest) to the seller company, in some cases, with the notional value of shares issued being set equal to an agreed value of the intangible and/or other asset(s) sold. Having divested ownership and possession to the purchaser corporation, the seller company may thereafter enter into an agreement to lease back such intangible or other asset(s). In some cases, as part of a leaseback agreement, the lessee may make rental or lease payments to the lessor. In addition, the purchaser corporation may pay dividends to the seller company on the transferred shares in the purchaser corporation's capital stock. With the seller company's intangible and/or other asset(s) having been converted at least partially into tangible investment assets in the form of shares in the issued capital stock of the purchaser corporation, the seller company may be granted access to a loan facility extended by the purchaser corporation, or other entity, using the seller company's acquired shares as collateral for a security interest given for any amounts drawn on the loan facility.

In such embodiments, the value of a seller company's intangible or other asset(s) may be calculated as the net difference between the seller's business value (as a going concern) and the value of the seller's net tangible (i.e., booked or listed) assets, such as real estate and other property, equipment, inventory, accounts and receivables, executory contracts, cash supplies, and the like. In some cases, business value may be estimated outside of a sale context based on the seller's annual profit(s) and/or revenue(s), e.g., such estimation involving scalar multiplication or other proportionality, or otherwise based on predicted future income. The seller's business value may also be estimated in some cases through direct (as opposed to indirect) valuation of intangible assets or its goodwill.

In such and/or other embodiments, a seller company's goodwill may be sold to the purchaser corporation on its own, as a separate and distinct asset from the seller's other tangible or intangible assets.

In some embodiments, a maximum value advanced to a borrower under a loan facility may be limited by the total value of intangible or other asset(s) sold. In some embodiments, amounts drawn periodically, pursuant to such loan facility, may further be set relative to, or capped at, one or more percentages of rental payments obligated by leaseback of intangible or other asset(s). In such manner, as a borrower's business continues to grow, causing fixed percentage lease payments to increase in proportion, a capped amount of periodic withdrawals by the borrower may also grow proportionally and cause additional cash flows to be realized or other capital to be made available.

In some embodiments, interest payable by a borrower on amounts drawn pursuant to a loan facility may be calculated and payable annually, in either a compounding or non-compounding fashion. Optionally, interest rates charged on such interest payments may be tied to one or more different economic metrics or indices, such as inflation or a consumer or other price index. In some cases, an interest rate may be calculated according to a given metrix or index, either with or without a percentage offset.

In some embodiments, pursuant to applicable provisions of law, it may be to the seller company's and purchaser corporation's agreed-upon option to elect for a deferment of income tax that might otherwise be payable on the seller company's disposition of intangible or other asset(s) in exchange for acquired shares in purchaser corporation's issued stock.

As will be understood by those skilled in the relevant arts, sellers, purchasers, lessors, and lessees as described herein may be of any legal form(s). They may, for example, comprise individuals, sole proprietorships, companies, partnerships, and/or corporations.

Further details of these and other aspects of the described embodiments will be apparent from the detailed description below.

### BRIEF DESCRIPTION OF THE DRAWINGS

Reference is now made to the accompanying drawings, in which:

FIG. 1 shows a schematic diagram representing an example company's financial position;

FIG. 2 shows an example re-distribution of various forms of wealth between a seller and purchaser corporation in accordance with the invention;

FIG. 3 shows an example sequence of transactions between a seller and purchaser corporation for achieving a re-distribution of wealth in accordance with the invention; and

FIG. 4 shows in a flow chart a method of re-distributing and realizing wealth based on the value of intangible assets in accordance with the invention.

### DETAILED DESCRIPTION OF EMBODIMENTS

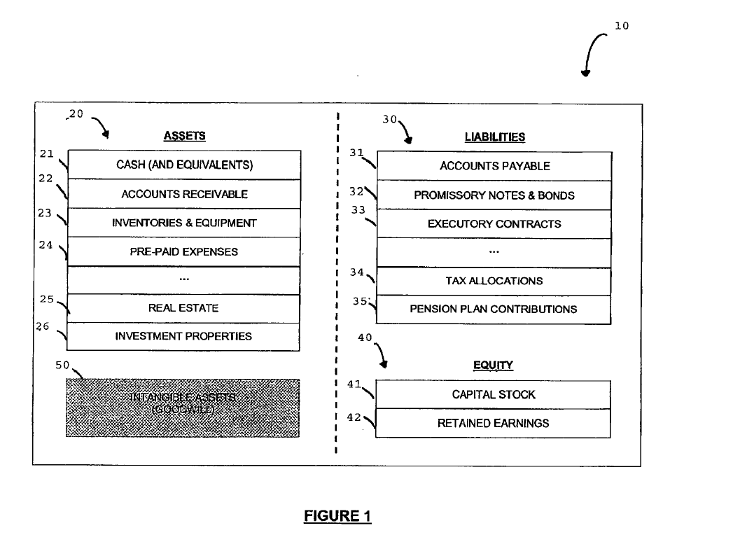

To provide a thorough understanding of the invention, various aspects, practical applications and embodiments of methods, concepts and ideas according to the disclosure, including at least one preferred embodiment thereof, are described with reference to FIGS. 1-4.

In many companies and other business organizations, including both public and private companies, it may often be the case that the recorded value of the company assets does not reflect the overall value of the company, in the sense of what the company may be worth to a potential purchaser as a going concern. Typically, though not necessarily, the net value of the recorded assets will be less than a fair sale price of the company (actual or estimated) as a going concern. In private companies, which are not floated on stock exchanges or electronic trading systems, going concern business value may sometimes only be ascertained with certainty upon actual sale from current to future owners. However, for public companies whose stock is floated on a stock exchange, going concern value may in some cases be reasonably estimated based on present levels of the company's stock price.

In either of the above two scenarios, an actual or estimated going concern sale price that is greater than the value of the company's net recorded, or otherwise perceived, assets may indicate that additional value exists within the company in one or more intangible forms that cannot easily be recorded using conventional accounting practices. Such additional value may derive from a number of different sources, and is often referred to as the company's “goodwill”. For example, goodwill may include the company's know-how, business processes, brand recognition, and/or customer/client lists, each of which may be extremely valuable to a company's success as a going concern, but the value of which may not easily be quantified in monetary terms.

Public companies that are floated on stock exchanges are generally availed of various mechanisms for raising capital. For example, stock offerings can provide such publicly traded companies with the option of raising capital by selling equity in the company to interested parties, which may include institutional as well as commercial investors, but more generally may include any member of the public. Due to factors such as brand recognition and demonstrated profitability, large public companies will very often also have the option of selling bonds and other debt instruments to raise capital by drawing upon public confidence in the company's ability to repay the debt upon maturation.

In relation to large public companies, options available to private companies for raising capital may be comparatively limited and more restricted. Initial public offerings of stock may be possible if the company has reached a stage where it is to the company's financial advantage. But not all privately held companies will be at (or perhaps ever reach) that stage. Even where possible, there may exist additional reasons (business, personal or otherwise) for not taking a company public and instead retaining private ownership. In some cases, capital can be raised by securing private investment in the company, for example, from venture capital or other source(s) of financing by means of loans and or stock offerings. However, for many companies, there is no guarantee of attracting private investment due to the associated risks involved for potential investors. Additionally, investors in private companies tend to require various assurances on their investment to mitigate the various risks to which they will be exposed. In many cases, investors will require (sometimes significant) rights of ownership and/or control over a company's business operations in exchange for their investment. High or preferred rates of return on their investment may also be demanded.

Historically, given the comparative restrictions that privately held companies may face when seeking to raise capital, goodwill has been a type of asset which has not been leveraged as security for loans, etc. A company's goodwill often represents a sizable, and sometimes the most valuable, asset in a company's possession. However, because goodwill is by definition an intangible asset, the value of which often cannot be known with certainty until after the company or its assests have changed ownership, it is often difficult to record goodwill in the company's financial records or reports. Currently used and applied financial accounting systems, such as the Generally Accepted Accounting Principles (GAAP) or International Financial Reporting Standards (IFRS), often operate based on cost accounting, as opposed to value or accrual accounting methodology. While goodwill may represent actual value to the company, it may nevertheless not be recorded, or otherwise recognized, by either GAAP or IFRS because the value of goodwill does not necessarily reflect its original cost to the Company.

In respect of both private and public companies, the inability to record intangible asset(s) on the company's financial records or reports according to conventional accounting practices, as a practical matter, may make it difficult to convert that wealth into present readily-available liquidity. The absence of goodwill and other intangible asset(s) from a company's records may produce a distorted picture of the company's value and finances. For example, the inability to record very valuable intangible assets may tend to cause undervaluation of a company's actual worth, e.g., by failing to reflect the company's going concern value. Companies may thereby be less able to trade effectively due to the fact that the company is unable to reflect its true value to potential trade partners.

Embodiments of the present invention provide method(s) of re-distributing and realizing wealth between one or more companies (or other entities) based on the value of goodwill and other intangible assets. Such method(s) may operate at least partially based on the idea that companies may be in possession of wealth—sometimes considerable wealth relative to the overall value of the company—that exists in an intangible form that cannot be positively expressed in the company's financial statements or record keeping. Accordingly, through a series of structured or independent transactions between two or more entities, a present and actual re-distribution of wealth may be realized as between companies that, in a practical sense, may convert or otherwise make wealth available to such companies that previously was not directly accessible. Present, real cash flows generated by a company on the basis of abstract wealth may be the net result of such transactions.

As those skilled in the relevant arts will readily understand, the transfer of wealth between companies and other entities is a very real and practical result, or application, of understandings and ideas, and carries with it a very wide range of practical opportunities, of numbers and varieties that it would be difficult to explain here or in any other forum. The results of such transfers can include continued employment for individuals or for very large numbers of people, the creation and distribution of physical goods, even the opportunity for affected individuals to eat, or to enjoy shelter.

Referring initially to FIG. 1, there is shown a representative diagram of an sample balance sheet 10 depicting a company's financial state or position at a selected point in time. Balance sheet 10 is merely illustrative of one particular approach to financial record-keeping and should not be construed as limiting the described embodiments in any way whatsoever. Balance sheet 10 generally records different sources of wealth in a company (e.g., assets, liabilities and equity) using a conventional double-entry bookkeeping system.

Accordingly, in the embodiment shown, balance sheet 10 includes entries for each of assets 20, liabilities 30, and equity 40. As shown in FIG. 1, assets 20 are depicted on one half of balance sheet 10, while liabilities 30 and equity 40 are grouped together on an opposite half of balance sheet 10 (reflecting the fundamental equation in many accounting systems that assets are equal to liabilities plus equity).

Intangible assets 50 are also indicated in balance sheet 10, on the same side as assets 20, as explained further below, to reflect the fact that intangible assets 50 very often have real value to a company. Intangible assets 50 are shown grayed-out, however, in recognition of the fact that there is often no entry on a balance sheet 10 for intangible assets 50, because of the associated difficulties in quantifying their exact value and, additionally, because many current accounting practices, such as IFRS and GAAP, are not premised on value accounting.

For illustrative purposes only, some common examples of each type of record found in a typical balance sheet 10 are shown. Assets 20 may include cash and equivalents 21, accounts receivable 22, inventories and equipment 23, pre-paid expenses 24, real estate 25, and other investment properties 26, such as stocks and bond, which may be held by a company and later exchanged for cash. Each type of asset(s) 20 may represent actual, discrete, and quantifiable assets to a company that may be transferred, sold, leased, used as collateral for a secured loan, or for any other present or future purpose generally.

Similarly, liabilities 30 may include, but are not limited to, accounts payable 31, promissory notes and bonds 32 that may be issued by a company, executory contracts 33 (e.g., which obligate a company to incur future expenses or to provide future performance), tax allocations 34, pension plan contributions 35, and so forth. Accordingly, each type of liability 30 shown in balance sheet 10 may represent actual, discrete, and quantifiable obligations of a company, present or future, which entail a net reduction in overall value.

The difference of assets 20 less liabilities 30 is recorded in balance sheet 10 as owner's equity 40, which may include capital stock 41 and retained earning 42, to name a few examples. Those skilled in the art familiar with the contents of this disclosure will understand that equity 40 may include other types of entries as well not specifically mentioned herein.

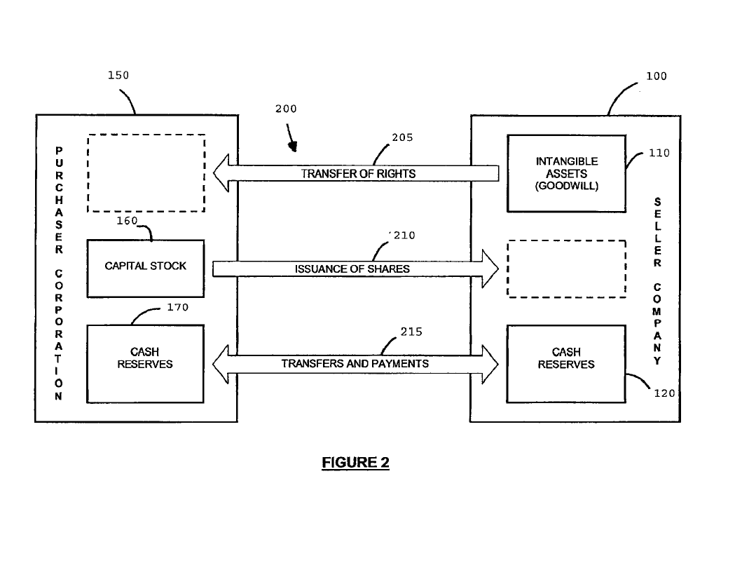

Referring now to FIG. 2, there is shown an example re-distribution of one or more forms of wealth between a seller company 100 and a purchaser corporation 150 in accordance with the invention. Seller company 100 can be any type of business organization or enterprise, without limitation, including a sole proprietorship, a partnership (limited or general), a corporation (private or public), a cooperative, or any other type of business organization generally. Purchaser corporation 150 may be any type of business organization, such as a corporation, from which shares in the company's capital stock may be issued to existing or prospective shareholders.

While only a single seller company 100 and a single purchaser corporation 150 are shown in FIG. 2, it will be understood that forms of wealth distribution and/or re-distribution described herein may apply equally to scenarios involving multiple different seller companies 100 and/or multiple different purchaser corporations 150. For example, a seller company 100 may transfer one type of wealth to one purchaser company 150 and another type of wealth to a second purchaser company 150 so as to effect an overall re-distribution. Alternatively, a seller company 100 may transfer one type of wealth to one purchaser company 150 and have transferred to them another type of wealth from a second purchaser company 150 so as to effect an overall re-distribution. In still further examples, two seller companies 100 may transfer wealth to a single purchaser company 150, either alone or in combination, with two purchaser corporations 150 transferring wealth to a single seller company 100. All such scenarios, variations and permutations are within the scope of the disclosure, and which are not intended to be excluded (unless context clearly dictates otherwise) by reference to a single seller company 100 or a single purchaser corporation 100.

Seller company(ies) 100 may own, or otherwise possess or have rights or interests in, a number of different assets of different types, such as the example assets 20 listed in balance sheet 10 of FIG. 1. In particular, as shown, seller company 100 may own various intangible assets (goodwill) 110 and cash reserves 120 or equivalents. As noted above, in some cases, intangible assets 110 may represent the net value in a company that is not recordable in balance sheets and other financial records as a discrete, tangible asset (but which is nonetheless realizable, e.g., through sale or change of ownership in the company). For profitable companies, intangible assets 110 may be positively valued and represent a significant percentage of the overall value of seller company 100.

Intangible assets 110 may comprise any accumulated goodwill belonging to seller company 100, such as know-how, business processes, brand recognition, and customer/client lists, as noted above. In some embodiments, intangible assets 110 may include such further items as a company's intellectual property (registered or otherwise) and/or trade secrets. Accordingly, embodiments of method(s) or process(es) described herein may be either inclusive or exclusive of such forms of intangible assets 110 other than a company's goodwill. Cash reserves 120 may include all presently owned cash or equivalents within seller company 100 and may further include future, as yet unrealized, sources of cash, such as receivable accounts, unpaid performance on contracts, and the like.

Purchaser corporation(s) 150 may create quantities of shares in the corporation's capital stock 160 that may be sold or offered to shareholders, such as seller company(ies) 100, on various terms or conditions as explained further herein. Purchaser corporation may also be in possession of cash reserves 170 or equivalents, derived from any number of sources of capital without limitation.

While intangible assets 110 may represent net positive value to seller company 100, much if not all of their value may be unrecorded and, while existing in such intangible form, relatively inaccessible to seller company 100. However, so as to realize the value of intangible assets 110 outside of a sale or change of ownership, seller company(ies) 100 may participate in one or more different wealth transfers 200 with purchaser corporation(s) 150 so as to effect an overall wealth re-distribution as between these various entities. As a practical matter, otherwise inaccessible intangible assets 110 may thereby be at least partially converted into present real cash flows for seller company 100, for example, which may be re-invested and used to grow seller company 100 or for any other purpose generally. In some cases, therefore, such re-distribution of wealth effectively unlocks pre-existing value in seller company(ies) 100, in addition to providing a source of capital for purchaser corporation(s) 150.

Examples of wealth transfers 200 that may be effected between seller company(ies) 100 and purchaser corporation(s) 150 are shown in FIG. 2. Wealth transfers 200 may take one or more of any of a wide variety of forms, and are not necessarily all of the same nature. Such forms may include, for example, asset transfers, licenses, leases and other grants of rights, issuances of shares, cash transfers and payments, and still others. The particular wealth transfers 200 shown in FIG. 2 are merely illustrative of the different types available between business entities.

For example, as shown in FIG. 2, seller company(ies) 100 may effect a transfer 205 to purchaser corporation 150 of rights in or to one or more of intangible assets 110, including goodwill, which may be owned by seller company(ies) 100. Transfer 205 of rights in intangible assets 110 may represent a complete transfer of rights or, alternatively, may represent a transfer of less than full ownership (sometimes referred to as a partial transfer of rights or a “bundle of rights”). While shown as a single transfer for convenience, transfer 205 of rights from seller company(ies) 100 to purchaser corporation(s) 150 may also be effected in multiple parts, structured or independent, and in some cases involving bilateral transfers, such that the overall effect of plural wealth transfers 205 between these entities is a net acquisition by purchaser corporation(s) 150 of at least a bundle of rights in seller company's intangible assets 110.

A second form of wealth re-distribution may be effected by purchaser corporation(s) 150 issuing shares of capital stock 160 to seller company(ies) 100. Any such shares of capital stock 160 issued to seller company 100 may thereafter be held as investment property and used for other business purposes, such as serving as collateral in secured lending. As shareholders of the purchaser corporation's capital stock 160, seller company 100 may also be entitled to receive dividends on the issues shares that may be declared and paid from time to time, depending on the terms, conditions and entitlements of such issued shares.

Another example form of wealth re-distribution that may take place between a seller company 100 and purchaser corporation(s) 150 are cash transfers and other payments 215. Such transfers and payments 215 may proceed bilaterally between seller company 100 or purchaser corporation(s) 150 and may arise in a number of different business contexts. For example, such transfers and payments 215 may be made subject to contractual obligation, as where a seller company 100 is providing payment for performance rendered by purchaser corporation(s) 150 or, alternatively, is making rental payments under a lease arrangement with purchaser corporation(s) 150.

In some cases, as a further example of wealth transfers 200, any of a wide variety of forms of cash transfers and payments 215 may be made or provided between a seller company 100 and purchaser corporation(s) 150 or other parties. Cash transfers and payments 215 may be made for any purpose, including ongoing needs of the seller company 100 for continuing business, and they may be made in a wide variety of forms.

Among the many types of wealth transfers 200, 215, are the creation of credit or loan facilities, and the transfer of preferred stock shares from a seller company 100 to purchaser corporation(s) 150, and subsequent payment of interest, dividends, and/or other consideration by such seller company 100 to such purchaser corporation(s) 150.

For example, a seller company 100 needing funds for expansion or continuation of a business may, subsequent to any or all of the processes described above, agree to a one-time loan, opening of a line of credit, or other form of loan, sale and/or other transfer some or all of a new or existing class of preferred shares to a purchaser corporation 150, in return for cash consideration which may then be applied to the needs of the seller company 100. Such transfer of preferred shares from the seller company 100 to the purchaser corporation 150 may be subject to a shareholder agreement comprising any desired and/or otherwise appropriate or desired terms. Such terms may be configured to accomplish any desired purpose.

For example, pursuant to such a shareholders' agreement, any or all preferred shares transferred under such conditions may be subject to repurchase and/or redemption by seller company 100 at any time such redemption is directed, or otherwise approved, by the board of directors of the seller company. As will be understood by those skilled in the relevant arts, once they have been made familiar with this disclosure, such repurchase and/or redemption may be ordered by the board at any suitable time and for any desired or required purpose. As will be further understood by such persons, the identity and/or other characteristics of one or more members of such board may be specified by the purchaser corporation 150, as a condition of execution of such a shareholder agreement.

As another example, pursuant to such a shareholders' agreement, any or all preferred shares transferred under such conditions may be subject to redemption by seller company 100 at any time, in the event of a change of control of the seller company 100. Such redemption may be conditioned upon any desired further conditions, including for example any or all of request by the purchaser corporation 150, change of business of the seller company, a change of control deemed hostile by the purchaser corporation 150 and/or the board of the seller company 100, etc. As will be further understood by those skilled in the relevant arts, any desired definition of “change of business” and/or “change of control” may be applied, including for example purchase of a controlling number of voting shares, change of a controlling number of board seats; shifting of revenue sources, identification of principal customers or industries, reporting requirements, etc.

As another example, pursuant to such a shareholders' agreement, any or all preferred shares transferred under such conditions may be subject to redemption by seller company 100 at any time, upon the death, retirement, termination, or other disability or incapacitation of any one or more specified individuals, including for example any key executives, managers, employees, and/or owners. Such redemption may be conditioned upon any desired further conditions.

As another example, pursuant to such a shareholders' agreement, any or all preferred shares transferred under such conditions may be subject to redemption by seller company 100 at any time, in the event of a material sale of the assets of the seller company 100. As will be understood by those skilled in the relevant arts, any desired definition of “material sale” may be applied, including for example “all or substantially all” of such assets, or an absolute or relative value, such as a specified percentage of the book value, gross or net worth, market capitalization, etc.

As will be understood by those skilled in the relevant arts, it can be advantageous, in many circumstances, that funds advanced by a purchaser corporation at 215 be secured, so as to minimize risk posed to the purchaser corporation in advancing the funds. A particularly advantageous means of securing such advancements offered by the invention is the use of one or more insurance policies.

Insurance policies used to provide security for advances made by a purchaser corporation 150 to a seller company 100 in accordance with the invention may be of any type(s) compatible with the purposes and processes disclosed herein. For example, insurance may be provided against any event(s) likely to have a detrimental effect on the ability of a seller company 100 to repay such an advance.

As a particularly advantageous example, insurance policy(ies) used to provide security for advances 215 can include one or more life, disability, and/or other incapacity policies adapted to provide coverage of persons associated with the seller company 100, including for example any one or more directors, executives, managers, technical and/or other key personnel.

Among other advantageous features provided by the invention is the application of proceeds of insurance policies used to secure advances to repayment of the advances. For example, it may be specified, by either or both of a credit facility agreement and a shareholders' agreement, and/or by any agreements governing the policy(ies) themselves, that in the event of occurrence of a covered event, such as the death, disability, or other incapacity of a covered person, any proceeds payable under the policy can be paid directly to the purchasing corporation, as a beneficiary under the policy, and applied toward repayment all or any portion of advanced funds.

As between a seller company 100 and purchaser corporation(s) 150, one or more transfers 200 of wealth may be offset, either partially or completely, by one or more other transfers 200 of wealth. As a result, the overall effect of plural transfers 200 of wealth may be a net gain by one, and a corresponding net loss by the other, of seller company 100 and purchaser corporation(s) 150. Alternatively, the overall effect of plural transfers 200 of wealth may be that no net gain or net loss is realized, notionally or otherwise, by either of seller company 100 and purchaser corporation(s) 150. Each separate entity involved in plural wealth transfers 200 may gain as much value as is lost so as to provide no net change overall.

A further potential effect of plural wealth transfers 200 is that, for either or both of seller company 100 or purchaser corporation(s), wealth may be re-distributed from one asset type to another. Thus, for example, the net effect of wealth transfers 200 for seller company 100 may be to re-allocate wealth that was initially attributable to intangible assets 110 into cash reserves 120 or, alternatively, into shares of purchaser corporation's capital stock 160. Likewise, plural wealth transfers 200 may have the practical effect for purchaser corporation(s) 150 of shifting wealth initially allocated to capital stock 160 into cash reserves 170 or, alternatively, into a bundle of rights in seller's intangible assets 110. Such practical result(s) or effect(s) may be arrived at whether or not plural wealth transfers 200 confer an overall net change in the total wealth of seller company 100 or purchaser corporation(s) 150.

In some embodiments, the various plural transfers 200 of wealth between seller company(ies) 100 and purchaser corporation(s) 150 may be agreed independently of each other. Alternatively, as explained further below, some or each of plural wealth transfers 200 may be agreed as constituent parts of an overall structured transaction or dealing between seller company(ies) 100 and purchaser corporation(s) 150, and which is designed to bring about an overall re-distribution and/or realization of wealth as between parties.

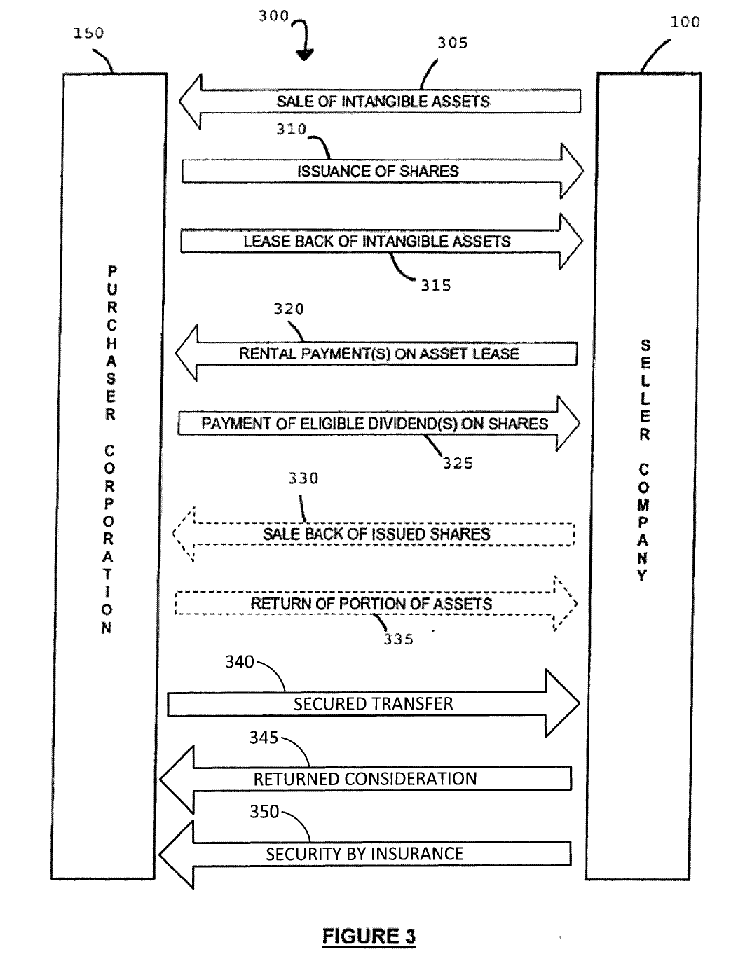

Referring also now to FIG. 3, there is shown an example sequence of transactions 300 between a seller company 100 and purchaser corporation(s) 150 for effecting a re-distribution and realization of wealth as between the parties to the transactions 300. The example sequence represents only one possible sequence of transactions 300, in a particular order and comprising a particular type and quantity, which may be completed between seller company 100 and purchaser corporation(s) 150. Within the context of the disclosure, however, a wide variety of other orderings, types and/or quantities of transactions 300 are both possible and suitable for use in implementing the invention.

While plural transactions 300 between a single seller company 100 and a single purchaser corporation 150 are shown in FIG. 3, it will be understood that the types and orderings of transactions and distributions described herein (and in other places throughout the disclosure) may equally be concluded between multiple different seller companies 100 and/or multiple different purchaser corporations 150. For example, a seller company 100 may engage in one transaction (of a certain type) with one purchaser company 150 and another transaction (of the same or a different type) with a second purchaser company 150 so as to effect an overall re-distribution of wealth between these three entities. Additionally, two different, potentially related purchaser corporations 150 may engage in one or more transactions, either independently from, or as part of an overall sequence of transactions 300 with a seller company 100 (or seller companies 100). All such scenarios, variations and permutations are within the scope of the disclosure, and which are not intended to be limited in any way (unless context clearly indicates otherwise) by reference to a single seller company 100 or a single purchaser corporation 150.

While not specifically illustrated, any or all of the transactions 300 shown in FIG. 3, moreover, may involve any of the various assets of seller company 100 and purchaser corporation(s) 150 shown (or not shown) in FIG. 2. Where applicable or convenient, reference to such assets shown in FIG. 2 may be made in the context of FIG. 3 as well.

In some embodiments, a seller company 100 may complete a sale 305 (more generally a transfer, disposition, or conveyance) of rights in intangible assets 100 to purchaser corporation(s) 150. The sale 305 may involve any or all rights to intangible assets 110 and, in some cases, may comprise an outright sale 305 of all right, title and interest in intangible assets 110. As noted above, the intangible assets 110 disposed of to purchaser corporation(s) 150 may comprise any built up goodwill in the seller company 100, either by itself or together with other types or forms of intangible assets in the possession of seller company 100.

As payment for the sale 305 of intangible assets 110 by seller company 100, purchaser corporation(s) 150 may issue 310 an allotment of shares in the capital stock 160 of purchaser corporation(s) 150. The number, type, attributes, and specific entitlements associated with or conferred by the allotment shares issued 310 to seller company 100 may vary in different embodiments of the invention. In some embodiments, the net value of the entire allotment of shares issued 310 may be notionally equal to the value of intangible assets 110 acquired by purchaser corporation(s) 150.

Because the value of intangible assets 110 may only be known inexactly until seller company 100 changes ownership or is sold, in some cases, an estimated value of the intangible assets 110 sold 305 may be calculated and utilized instead of an actual known value. Based on the estimated value of the intangible assets 110, a number and respective per unit price of the shares issued 310 to seller company 100 may be determined so as to provide notionally equal value as the sale price of the intangible assets 110.

Different approaches to estimating value(s) of intangible assets 110 are suitable for use in implementing method(s) or process(es) for distributing wealth in accordance with the disclosure, including approaches based directly or indirectly on an accepted going concern value of seller company 100. In some embodiments, for example, the accepted business value of seller company 100 as a going concern may be estimated taking into consideration annual or historic profits of seller company 100 and a valuation multiplier. Recorded net tangible assets of seller company 100 may then be subtracted from the accepted business value in order to calculate residual remaining in seller company 100, e.g., goodwill.

For example, seller company 100 may have $1,500,000 in reported annual (or average annual) profits and $900,000 in recorded net tangible assets. The accepted business value of seller company 100 may be taken as a scalar valuation multiplier of reported annual (or average annual) profits. Using a valuation multiplier of 3 (although any valuation multiplier may generally be used in various embodiments), an estimate of accepted business value may be calculated as follows:

$$\frac{\begin{matrix}Valuation Multiplier \\ Annual Profit\end{matrix}}{Accepted Business Value} \frac{\begin{matrix}3 \\ \times \$1 , 500 , 000\end{matrix}}{= \$4 , 500 , 000}$$

Given recorded net tangible assets (in this numerical example) of $900,000, an estimate of the value of intangible assets 110 owned by seller company 100 may be calculated as follows:

$$\frac{\begin{matrix}Accepted Business Value \\ Net Tangible Assets\end{matrix}}{Value of Intangible Assets} , = \frac{\begin{matrix}\$4 , 500 , 000 \\ - \$900 , 000\end{matrix}}{= \$3 , 600 , 000}$$

Given both the estimated value of intangible assets 110 sold 305 to purchaser corporation 150 and the number of shares issued 310 to seller company 100, the sell price of each issued share may be set at a level so that the overall value of the entire share allotment is notionally equal to the estimated value of the intangible assets 110. As the value of the intangible assets 110 may fluctuate over time, the corresponding share price of the purchaser corporation's capital stock 160 may also change accordingly to maintain value equivalence between the two assets.

While valuation multipliers represent one possible approach to estimating an accepted business value for a seller company 100, other numerical and/or statistical approaches may alternatively be utilized. For example, statistical methods based on historic or predicted future profits, as well as other economic indicators or metrics may be used in estimating a going concern value of a seller company 100.

In some cases, a seller company 100 and a purchaser corporation 150 may engage in a further transaction, or transactions, by which certain of the newly acquired rights in intangible assets 110 are conveyed back to seller company 100. For example, use and possession of the intangible assets 110 may be leased back 315 to seller company 100 on any acceptable terms or conditions agreed between parties. Accordingly, from a practical standpoint, the overall effect of sale 305 and leaseback 315 as a transactional pair may be for seller company 100 to transfer legal ownership in intangible assets 110 to purchaser corporation(s) 150, while at the same time retaining certain rights of use and/or control thereof.

While ownership of the full right, title and interest to intangible assets 100 would also entitle seller company 100 to such rights of control and/or use as were (re-)acquired through leaseback 310, the combination of transactions 305 and 315 may allow seller company 110 to retain (or regain) such rights, but at the same time acquire shares in capital stock 160 and all associated rights and entitlements therewith (including the right to earn dividends on the shares). Thus, through acquisition 310 of the shares, seller company 110 is able to have the value of intangible assets 110, which is un-recordable in a system of cost as opposed to value accounting, transferred into tangible assets of notionally equal value, i.e., shares in capital stock 160.

In a double-entry bookkeeping system, acquisition 310 of shares may be recorded on a balance sheet 10 (FIG. 1) as a type of asset 20, which is offset by a corresponding entry in equity 40 of notionally equal value. So long as intangible assets 110 could not per se be recorded in balance sheet 10, no corresponding entry in equity 40 would be permissible under, e.g., GAAP, IFRS and other cost accounting systems. Thus, sale 305 of rights in intangible assets 110 combined with issuance 310 of notionally equal shares in capital stock 160 permits the value of intangible assets 110 to be recorded as equity 40, thereby providing a truer reflection of the value or wealth accumulated in a seller company 100.

While the sequence of sale 305, share issuance 310 and leaseback 315 may represent one possible way of re-distributing wealth associated with intangible assets 110 between seller company 100 and purchaser corporation(s) 150, it may be apparent that other numbers, types and/or orderings of transactions 300 may bring about the same or a similar result.

As part of a leaseback 315 agreed between seller company 100 and purchaser corporation(s) 150 for use and possession of intangible assets 110, seller company 100 may be obligated to make lease or rental payments 320 to purchaser corporation 150. For example, seller company 100 may draw upon cash reserves 120 for such payments, which thereafter may be added, temporarily or permanently, to cash reserves 170 of purchaser corporation(s) 150 or else allocated to some other business purpose. Rental payments 320 may be made to purchaser corporation(s) 150 on a periodic basis, such as monthly or yearly, or at some other regular interval, but alternatively may be made aperiodically as well.

In some embodiments, the amount of the rental payments made 320 to purchaser corporation(s) 150 may be at least partially determined based on the profitability of seller company 100. A further consideration in the calculated amount of the lease payments made 320 by seller company 100 may be the value of the intangible assets 110 being leased back 315, in relation to (e.g., as a proportion of) the accepted business value of the seller company 100. For example, in some cases, the amount of the lease payments as a proportion of annual revenue for the seller company's 100 may be equal or approximately equal to the value of intangible assets 110 as a proportion of the accepted business value of seller company 100. By structuring the lease payments in this manner, the amount of the payment made 320 may grow in approximate proportion to the value of intangible assets 110 over time, and may also correspond in some manner to annual profits earned by seller company 100, i.e., gross revenues less operating expenses.

In the numerical example above, for a seller company 110 with an accepted business value of $4,500,000, of which $3,600,000 is attributable to intangible assets, the seller company's goodwill as a percentage of business value may be calculated as follows:

$$\frac{\begin{matrix}Value of Intangible Assets \\ Accepted Business Value\end{matrix}}{Goodwill as \% of Business value} \frac{\begin{matrix}\$3 , 600 , 000 \\ \div \$4 , 500 , 000\end{matrix}}{= 80 \%}$$

Based on the calculated goodwill as a percentage of business value, an annual rental payment 320 to be made by seller company 100 to purchaser corporation 150, as a percentage of annual revenue, may then be calculated as follows:

$$\frac{\begin{matrix}Profit margin \\ Goodwill as \% of Business value\end{matrix}}{Lease payment as \% of Revenue} \frac{\begin{matrix}15 \% \\ \times 80 \%\end{matrix}}{= 12 \%}$$

By valuing lease payments in the same proportion to profitability as the goodwill of a seller company 100 is in relation to business value, the lease payments made 320 may thereby reflect the value of the intangible assets 110 that were sold 305 as related to the profits earned by seller company 100.

Accordingly, for an annual revenue (in this numerical example) of $1,500,000 in a certain year, according to the above calculations, the rental payments made 320 to purchaser corporation(s) 150 for seller company's use and/or control of intangible assets 110 may be equal to $180,000 for that year. But as annual revenue grows year by year, the dollar value of the lease payments may grow in substantial or equal proportion, which may help to ensure sustained growth of seller company 100.

In some embodiments, purchaser corporation(s) 150 may collect lease payments from seller company 100 and, if and when declared, distribute 325 such capital as dividends on shares in the capital stock 160 acquired by seller company 100. Purchaser corporation(s) 150 may first set aside some portion of the lease payments received. For example, in some cases, purchaser corporation(s) 150 may set aside a portion of the lease payment for any applicable tax allowance, which is then paid to a revenue agency or the like as opposed to being distributed to seller company 100 as paid dividends. Otherwise all or substantially all of the rental payments received by purchaser corporation(s) 150 may be distributed to seller company 100 as dividends.

Depending on the specific entitlements associated with issued shares in capital stock 160, seller company 100 may from time to time receive payment 325 of dividends from purchaser corporation(s) 150, provided seller company 100 has retained its interest in such shares. However, seller company 100 may also be provided with an option to sell back or redeem 330 some portion of the shares that were initially issued 310. The option to redeem may be exercised once, repeatedly, or not at all, in such manner that the seller company 100 may, in effect, gradually sell back some portion or all of the held shares in the purchaser corporation's capital stock 160. As part of a share redemption agreement, purchaser corporation(s) 150 or another entity(ies) may provide payment 335 of a money equivalent to the notional value of the shares being returned (as originally agreed between seller company 100 and purchaser corporation(s) 150 during sale 305 and issuance 310).

Thus, for example, if seller company 100 were to redeem 330 a quantity of shares equal to 5% of the initial, total allotment, the money payment provided 335 by purchaser corporation(s) 150 or other entity(ies) may in some cases be equal to 5% of the originally estimated value of the intangible assets 110 as part of sale 305. In this manner, if the entire allotment of shares held by seller company 100 were, over time, to be sold back or redeemed 330 by purchaser corporation(s) 150 or other entity(ies), then the total payment provided 335 for such redemption might equal the total estimated value of the intangible assets 110.

Within this context, the skilled person will appreciate that the value of the shares sold back or redeemed 330 by purchaser corporation(s) 150 or other entity(ies) may change over time as the value of intangible assets 110 either appreciates or depreciates in value. For example, changing profitability of seller company 100 might influence a seller company's accepted business value, which in turn would be likely to affect the value of its goodwill in a commensurate manner. However, in some embodiments, the redemption price of shares purchased back 330 by purchaser corporation(s) 150 or other entity(ies) may nonetheless reflect the original estimate of the value of intangible assets 110, even as new estimate(s) over time might reflect different value(s) of intangible assets 110.

Another practical effect brought about by sale 305 and lease back 315 of intangible assets 110, in exchange for or in combination with issuance 310 of shares in the purchaser corporation's capital stock 160, is that seller company 100 is able to acquires a tangible, recordable asset, i.e., shares in capital stock 160, which may serve as collateral for loans and other credit arrangements. Such alternative state of affairs is brought into existence through at least partial conversion of intangible assets 110 into shares of capital stock 160, which are discrete assets and, having an associated cost, which are recordable in the financial records of seller company 100. As used herein throughout, terms or expressions such as “alternative state of affairs” may be used to designate factual situations or conditions that were not pre-existing and that may reasonably be attributed to or correlated with one or more actions purposefully taken, or to consequences or causal relationships associated therewith.

Accordingly, in some embodiments, at 340 further re-distribution and realization of wealth as between seller company 100 and purchaser corporation(s) 150 may be achieved by a secured transfer of funds from purchaser corporation(s) 150 to seller company 100. For example, extension of a loan or creation of a loan facility by purchaser corporation(s) 150 (or perhaps some other lending or financial institution) to seller company 100 and/or by purchase by purchaser corporation 150 of shares of stock having one or more preferred terms, including for example preferred dividend payments, may be secured at 350 by means of one or more insurance policies, as described herein.

Thus, in order to allow a seller company 100 access to revenues for continuing or expanding business, or for any other purpose, at 340 seller company 100 and purchaser corporation 140 may complete one or more further agreements, as for example a term or revolving credit agreement, or other loan facility, and/or one or more shareholder agreements, pursuant to which purchaser corporation 140 transfers cash, and/or any other value or consideration, to seller company 100 in return for loan repayment(s), delivery 345 by seller company 100 to purchaser 140 of one or more preferred shares of equity stocks or other securities in the seller company 100, etc.

Loan facilities in accordance with such embodiments or aspects of the invention may, for example, take the form of a line of credit or other similarly or equivalently structured financing arrangement whereby seller company 100 is granted access to funds not to exceed a fixed, pre-determined limit.

In some embodiments, a credit facility extended to seller company 100 may be limited by the estimated value of intangible assets 110 acquired by purchaser corporation(s) 150. In such cases, seller company 100 would not receive more in principal loan advances than did purchaser corporation(s) 150 acquire in the form of the intangible assets 110 (and therefore also not more than the value of the shares in capital stock 160 held by seller company 100). By taking a security interest in such held shares, the credit facility extended by purchaser corporation(s) 150 may be fully secured against default by seller company 100. Given the relative strength of such security, purchaser, corporation(s) 150 may therefore be able to extend a credit facility to seller company 100 without insisting on other conventional measures noted above for protecting its investment, e.g., rights of ownership and control in seller company 100 or relatively high or preferential return on investment.

In the case of the extension of loan(s) or credit, seller company 100 may be required to make interest and/or other payments on the loan, in addition to principal repayment(s). Such interest payments may become payable as soon as an outstanding loan balance is developed and may continue up until the full term of the loan. In such cases where repayment 350 of the outstanding loan balance is permitted in installments according to a repayment plan, interest payments may continue beyond the full term of the loan until the entire outstanding balance is repaid by seller company 100.

As will be understood by those skilled in the relevant arts, any preferred or preferential shares issued at 340 may be voting or non voting, and may require payment at 350 by seller company 100 to purchaser corporation 150 of a periodic dividend, and/or special dividend(s) triggered by one or more specified events or payable under other specified conditions.

In the case of either creation of a loan facility or transfer of preferred shares at 340, at 345 the seller company 100 may be required to return loan payments, interest, dividends, and/or other consideration to the purchasing corporation 150.

In the case of creation of a loan facility at 340, at 345 an amount and type of interest charged on the loan facility may vary, in different embodiments. In some cases, simple interest may be calculated yearly, at a rate that is determined by a consumer price index (CPI) or other financial or economic metric. For example, the rate of interest charged may be set at a fixed amount, e.g., 2.5%, above the CPI. In this manner, purchaser corporation(s) 150 may lend to seller company 100 at a rate that is equal to or better than inflation, but which still may be considerably lower than interest rates offered by other commercial lending or financial institutions.

In some cases, a loan facility may be extended to seller company 100 for a fixed term, such as, but not limited to, a specific number of months or years. Thus, seller company 100 may be entitled to draw 340 advances against the loan facility until the end of such fixed term, at which point whatever outstanding balance is existing would become due and payable. Repayment of the outstanding loan may be required immediately at the end of the fixed term of the loan or, alternatively, according to an agreed-upon re-payment plan.

At any point during a fixed term of a loan, a seller company 100 may also be entitled, upon notice to purchaser corporation(s) 150, to prematurely terminate the loan facility through re-payment at 350 of the outstanding loan balance. In some cases, a penalty for early termination may be applied, the size of the penalty depending for example on the relative timing of the termination. The amount of the penalty may also generally be calculable as a percentage of the maximum available loan facility. For example, and for illustrative purposes only, for early termination of a 5-year loan, the termination penalty may be 10% of the loan balance for termination prior to the end of the 1^{st} year, 8% for termination before the end of the 2^{nd} year, 6% for termination before the end of the 3^{rd} year, 4% for termination before the end of the 4^{th} year, and 2% for termination before the end of the 5^{th} year. However, as the skilled person familiar with this disclosure will appreciate, amounts and methods of calculating early termination penalties other than a linear function of remaining loan term may be utilized as well.

In embodiments of the invention in which preferred shares in seller company 100 are sold to purchasing corporation(s) 150 at 340, at 345 seller company 100 may pay to such purchaser corporation(s) 150 cumulative, preferred dividends, at a rate equal to or otherwise associated with inflation, or some offset or measure relative thereto, including for example local consumer price index or some percentage point offset therefrom (e.g., United States, Canadian, or locally applicable CPI plus X percent). As previously explained, preferred shares transferred at 340 may be redeemed by the seller company 100, and dividends payable at 345 thereby curtailed, under a wide variety of conditions, some or all of which may be specified in a shareholder agreement concluded at 340.

As security for the advancement of funds at 340 and/or return of consideration at 345, at 350 seller company 100 may be required to provide obtain one or more insurance policies, in favor of purchasing corporation(s) 150 as beneficiaries, as described herein. The acquisition of such insurance may for example be a required condition of signature, at 340, of a loan agreement or share purchase agreement by purchaser corporation(s) 150. As previously described, such insurance policy(ies) may include one or more life, disability, and/or other incapacity policies adapted to provide coverage of persons associated with the seller company 100, including for example any one or more directors, executives, managers, technical and/or other key personnel; and such policy(ies) may specify that in the event of occurrence of an insured or otherwise covered event, such as the death, disability, or other incapacity of an insured person, any proceeds payable under the policy can be paid directly to the purchasing corporation, as a beneficiary under the policy, and applied toward repayment of any portion, or all, of advanced funds.

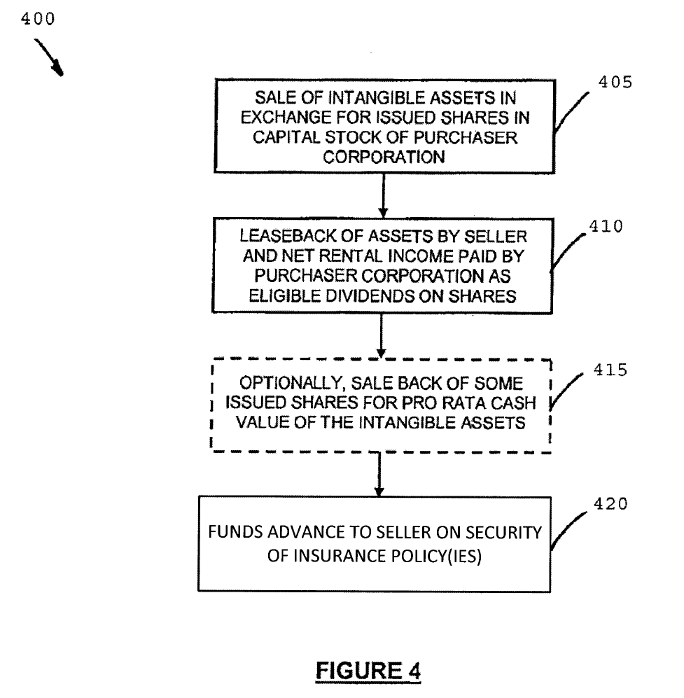

Referring now to FIG. 4, there is illustrated, in a flow chart, method(s) 400 of re-distributing and realizing wealth based on the value of intangible assets. Such method(s) 400 may be performed, for example, by a seller company 100 and one or more purchaser corporations 150 (FIG. 2) engaging in one or more of transactions 300 (FIG. 3). For clarity and brevity, description of method(s) 400 may be abbreviated in places (further details to be found above with reference to FIGS. 2 and 3).

At 405, one or more intangible assets of a company (such as seller company 100) are sold to a corporation (such as purchaser corporation 150) in exchange for or in combination with an allotment of shares in the purchasing corporation. Intangible assets sold at 405 may include a company's goodwill, either inclusively or exclusively or other intangible assets owned by the selling company. Moreover, the quantity and per unit price of the issued shares may be such that the overall value of the share issuance is notionally equal to the value of the intangible assets sold.

At 410, rights in intangible assets acquired by the purchasing corporation may be leased back to the selling company. For example, while the purchasing corporation may retain legal ownership over the acquired intangible assets, use, possession, and other control may be leased back to the selling company. As part of the lease agreement for use and/or control of intangible assets, the selling company may be obligated to make rental payments to the purchasing corporation, a portion of which may be returned to the selling company (after due allowance for applicable taxes) as dividends on the held shares, if and when declared by the purchasing corporation. The amount of the rental payments under the lease may optionally be fixed in relation to, and thereby made to automatically grow or shrink with, the profitability of the selling company.

At 415, the selling company may have the option to sell back or redeem some portion of the held shares in the purchasing corporation for a price determined pro rate with the value of the intangible assets. Accordingly, through repeated exercise of such option, the selling company may sell back its complete allotment of shares in the purchasing corporation for a total value that is notionally equal to the value of intangible assets as determined based on original estimates. Such option to sell back may in some cases be at the complete discretion of the selling company. Accordingly, should the option not be exercised in such cases, selling company would be entitled to continue receiving dividends on the portion of shares still owned.

At 420, the purchasing corporation(s) 150 may advance loans to seller company 100, and/or purchase from seller company 100 shares of stock carrying preferred dividends and/or other preferential terms, and seller company 100 may conclude a corresponding loan and/or shareholders' agreement. Such agreement(s) may require that seller company 100 acquire, as security for the advancement of funds by purchaser corporation(s) 150 via such loan(s) and/or stock purchases, one or more insurance policies, the policies comprising terms making any payments payable to purchaser corporation(s) 150 upon occurrence of an insured event. In some preferred embodiments of the invention, insurance payments made on occurrence of such insured event(s) may be payable directly to the purchaser corporation(s) 150, for example as beneficiaries under such policies, rather than to seller company 100 or some other person or entity.

Through performance of method(s) 400, an initial distribution of wealth as between a selling company and a purchasing corporation that was not necessarily advantageous to selling company may be altered according to a re-distribution of wealth that confers one of more practical benefits onto selling company (as well as the purchasing corporation). For example, but without limitation, selling company is able based on the value of specified intangible assets to acquire tangible, recordable assets through which to generate present real cash flows that otherwise might not have been available, and thereby to remain in business, retain its status as an employer, and provide goods and/or services to customers. In any event, the selling company is also able to perform a balance sheet adjustment by having the previously unrecordable value of intangible assets reflected as owner's equity.

While the method(s) and process(es) described herein may be useful for, or have such practical effects as, collateralizing intangible assets and performing balance sheet readjustments and thereby opening wide ranges of physical and ecomonic possibilities, still other uses and practical effects of the ideas and concepts described herein may be possible.

For example, referring back to FIG. 3, another practical effect of converting intangible assets 110 into shares in capital stock 160 (e.g., through sale 305 in exchange for, or in combination with, acquisition 310) is that the assets of seller company 100 may have different relative values to a given entity before and after such conversion. Thus, while goodwill or intangible assets 110 may have a certain value to some entity (e.g., a trade partner of seller company 100), shares in capital stock 160 may not have equal value and, in some cases, may have dramatically reduced or essentially no value to such other entity. Conversion of valuable intangible assets 110 to comparatively less valuable shares in capital stock 160 may therefore offer seller company 100 some measure of protection against the claims of other entities.

Moreover, the advancement of loans and/or issuance of preferred stock and/or payment of dividends, as described for example in conjunction with FIG. 3, can enable both seller and purchaser entities to carry on, expand, and/or otherwise execute business plans, with all the practical results thereof described herein.

In some embodiments, the method(s), process(es) and other practical applications described herein need not be applied only to goodwill. For example, some companies, such as real estate and investment firms, tend to have relatively high proportions of assets having well-defined values, and in some cases do not to generate as much or as valuable goodwill as other companies that have relatively highly-developed developed brands, business know-how, business processes, customer/client bases, etc. In the case of such other companies, embodiments of the present invention may confer useful benefits and/or advantages by operating on other types of intangible but still valuable assets. As one example, rather than goodwill, intangible assets such as equitable rights of redemption on mortgages may provide a basis for wealth redistributions according to any of the transactions between a seller company and one or more purchaser corporation described herein.

In still other embodiments, the method(s), process(es) and practical applications described herein need not apply to intangible assets and instead may operated substantially as described herein based on tangible assets.

The above description is meant to be exemplary only, and one skilled in the art will recognize that changes or variations may be made without departing from the scope of the embodiments disclosed herein. Such modifications which fall within the scope of the described embodiments may be apparent to those skilled in the art, in light of a review of this disclosure, and such modifications are intended to fall within the appended claims. For example, except to the extent necessary or inherent in the processes themselves, no particular order to steps or stages of methods or processes described in this disclosure, including the drawings appended hereto, is intended or implied. In many cases, the order of process steps may be varied without changing the purpose, effect, or import of the method(s) and process(es) described.

Those skilled in the relevant arts will further understand that, in many embodiments of the invention, relations between buyers, sellers, and other parties may be governed or otherwise memorialized through the use of written contracts.

The scope of the invention is to be defined solely by the appended claims, giving due consideration to applicable rules and principles of construction, such as the doctrine of equivalents and related doctrines, which may be utilized so as to understand the full scope and meaning of such claims as is consistent with the intentions expressed or otherwise implied within this disclosure.

What is claimed is:

1. In a method of distributing wealth comprising purchase of one or more assets of a seller company by a purchaser corporation in exchange for a plurality of shares in the issued stock of the purchaser corporation, the value of the issued shares determined based on the value of the assets sold; lease-back by the purchaser corporation to the seller company of purchased intangible assets; payment by the purchaser corporation of at least a portion of a net income generated from the lease payments of the seller, as dividends issued in respect of the shares exchanged for the purchased intangible assets; and holding by the purchaser corporation of the shares exchanged for the purchased intangible assets, as security for the lease-back of the purchased assets; the improvement comprising:
advancement by the purchaser corporation to the seller company of funds secured by at least one insurance policy.

2. The method of claim 1, wherein the advancement of funds to the seller company is in the form of a loan facility.

3. The method of claim 2, wherein an amount available to the seller company pursuant to the loan facility is capped based on a value of the at least one asset.

4. The method of claim 2, wherein at least partial repayment to the purchaser corporation of funds provided to the seller company under the loan facility is made using proceeds of the at least one insurance policy.

5. The method of claim 1, wherein the advancement of funds to the seller company is in the form of a purchase by the purchaser corporation of dividend-bearing preferred shares in the seller company.

6. The method of claim 5, wherein purchase of the preferred shares by the purchaser corporation is subject to a shareholder agreement which allows redemption of the preferred shares by the seller company at any time approved by a board of directors which controls the seller company.

7. The method of claim 5, wherein purchase of the preferred shares by the purchaser corporation is subject to a shareholder agreement which allows redemption of the preferred shares by the purchaser corporation in the event of a change of control of the seller company.

8. The method of claim 5, wherein purchase of the preferred shares by the purchaser corporation is subject to a shareholder agreement which allows redemption of the preferred shares by the purchaser corporation in the event of a material sale of assets of the seller company.

9. The method of claim 5, comprising receipt by the purchaser corporation of a dividend paid by the seller company for each preferred share.

10. The method of claim 1, wherein the at least one insurance policy insures the life of at least one person associated with the seller company.

11. The method of claim 10, wherein the person is an owner of the seller company.

12. The method of claim 10, wherein the person is a manager of the seller company.

13. The method of claim 10, wherein the person is an executive of the seller company.

14. The method of claim 10, wherein the person is a member of the board of directors of the seller company.
